(19) United States
(12) Patent Application Publication
(10) Pub. No.: US 2014/0344901 A1
(43) Pub. Date: Nov. 20, 2014

(54) Method And System For Sharing A File

(71) Applicant: TENCENT TECHNOLOGY (SHENZHEN) COMPANY LIMITED, Shenzhen (CN)

(72) Inventor: Guowei FU, Shenzhen City (CN)

(21) Appl. No.: 14/449,216

(22) Filed: Aug. 1, 2014

Related U.S. Application Data
(63) Continuation of application No. PCT/CN2013/070105, filed on Jan. 6, 2013.

(30) Foreign Application Priority Data
Feb. 20, 2012 (CN) 201210038208.3

(51) Int. Cl. H04L 29/08; H04L 29/06

(52) U.S. Cl. CPC H04L 67/06; H04L 63/08
USPC 726/4; 709/204

(57) ABSTRACT

A method and system for sharing a file. The method includes: receiving a download request comprising a download address sent by a user terminal provider; according to the download request, downloading a file from the download address, storing the file, and sending a link address where the file is stored to the user terminal provider; receiving a sharing request comprising a link address sent by a user terminal requester, and sending a file corresponding to the link address to the user terminal requester.

### CROSS-REFERENCE TO RELATED APPLICATIONS

This application is a continuation of PCT/CN2013/070105 filed on Jan. 6, 2013, which claims the benefit and priority from Chinese Application No. CN201210038208.3, entitled “Method And System For Sharing a File” and filed on Feb. 20, 2012. The entire disclosures of each of the above applications are incorporated herein by reference.

### FIELD

The present disclosure relates to method and system for sharing a file.

### BACKGROUND

This section provides background information related to the present disclosure which is not necessarily prior art.

In daily application, files downloaded by various user terminals normally need to be shared. A conventional method for sharing a file mainly includes the following: each user terminal requests to download a required file from the network side, stores the downloaded file to the local network, and shares the file. Subsequently, other user terminals in a Local Area Network (LAN) where the user terminal is located may access the file shared by the user terminal. The user terminal sharing the file is usually called the user terminal provider, and the user terminal accessing the file shared by the user terminal provider is usually called the user terminal requester.

The conventional method for sharing a file mainly has the following defects.

When the user terminal provider is offline, such as when the user terminal shuts down or does not access the network, the user terminal requester will be incapable of accessing the file shared by the user terminal provider. Thus, even if knowing that the user terminal provider stores corresponding file data, the user terminal requester can only download the file from the network side, which increases the download load of the network. In addition, the internet resources have a lifecycle. When popular resources gradually become unpopular resources, it will be difficult for users to easily obtain the resources from the network side, and it becomes difficult to find a resource download entrance, such as ED2K-linked resources and Bittorrent (BT) seeds. Therefore, for the unpopular resources, even if knowing that the user terminal provider stores a corresponding file, the user terminal requester is not able to obtain the corresponding file due to the fact that the user terminal provider is offline.

Therefore, in the existing method for sharing a file, when the user terminal provider is offline, the file sharing will not be performed.

### SUMMARY

This section provides a general summary of the disclosure, and is not a comprehensive disclosure of its full scope or all of its features.

In view of above, examples of the present disclosure provide a method for sharing a file and a system for sharing a file, which can achieve file sharing when the user terminal provider is offline.

The method for sharing a file provided by examples of the present disclosure includes:
receiving a download request including a download address sent by a user terminal provider;
according to the download request, downloading a file from the download address, storing the file, and sending a link address where the file is stored to the user terminal provider;
receiving a sharing request including a link address sent by a user terminal requester, and sending a file corresponding to the link address to the user terminal requester.

The system for sharing a file provided by examples of the present disclosure includes:
a first subsystem, wherein the first subsystem comprises: an offline download management unit, an offline downloader, a storage unit, and a data access unit;
the offline download management unit is configured to receive a download request, including a download address sent by a user terminal provider, and send the download address to the offline downloader; receive a link address sent by the offline downloader, and send the link address to the user terminal provider;
the offline downloader is configured to download a file from the download address, store the downloaded file in the storage unit, and send the link address where the file is stored to the offline download management unit;
the data access unit is configured to receive a sharing request including a link address sent by a user terminal requester, obtain a file corresponding to the link address from the storage unit, and send the file to the user terminal requester.

From the above technical solutions it can be seen that in the present disclosure, files downloaded by various user terminals are stored centrally, and a corresponding file is provided according to a sharing request including a link address of the file. Thus, it is not necessary for each user terminal to store the file in the local, and the defect that the file sharing will not be performed when the user terminal provider is offline is also avoided.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart illustrating a method for sharing a file according to various embodiments;

FIG. 2 is a flowchart illustrating a method for downloading a file according to various embodiments;

FIG. 3 is a flowchart illustrating a method for accessing a shared file according to various embodiments;

FIG. 4 is a schematic diagram illustrating a system for sharing a file according to various embodiments.

Corresponding reference numerals indicate corresponding parts throughout the several views of the drawings.

### DETAILED DESCRIPTION

Example embodiments will now be described more fully with reference to the accompanying drawings.

In order to make objectives, technical solutions, and advantages of the present disclosure clearer, the present disclosure will be described in detail hereinafter with reference to accompanying drawings.

In a non-limiting example of the present disclosure, the network side stores files downloaded by each user terminal, and a corresponding file is provided according to a sharing request including a link address. FIG. 1 is a flowchart illustrating a method for sharing a file according to various embodiments. As shown in FIG. 1, the method may include the following operations.

In block 101, a download request including a download address sent by a user terminal provider is received.

In block 102, a corresponding file is downloaded from the download address, the downloaded file is stored, and a link address where the file is stored is fed back to the user terminal provider.

The link address is a store address of the file.

Before the corresponding file is downloaded from the download address in block 102, the method may further include the following: a determination as to whether the user terminal provider has an offline download permission may be made; when the user terminal provider has the offline download permission, the step for downloading the corresponding file from the download address is performed, otherwise, the file is not downloaded.

The method for determining whether the user terminal provider has an offline download permission may be achieved through many means. For example, it may be achieved by determining whether storage space is allocated for the user terminal provider. That is, a determination as to whether storage space is allocated for the user terminal provider is made and when the storage space is allocated for the user terminal provider, a determination as to whether there is enough space left in the allocated storage space is further made. When there is enough space left in the allocated storage space, it is determined that the user terminal provider has the offline download permission.

When no storage space is allocated for the user terminal provider, a determination as to whether it is allowed to allocate storage space for the user terminal provider is further made. When it is allowed storage space is allocated for the user terminal provider and it is determined that the user terminal provider has the offline download permission.

Further, each user terminal provider may be given a set permission level. Permission levels include level one through level seven. Level one is the lowest level, and a user terminal provider with level one does not have the offline download permission. As for level two through level seven, storage space with different capacity is respectively allocated for corresponding user terminal providers according to the permission levels possessed by the user terminal providers, and the user terminal providers with level two through level seven have the offline download permission.

Before the corresponding file is downloaded from the download address in block 102, the method may further include the following: a determination as to whether a file corresponding to the download address is stored is made; when no file corresponding to the download address is stored, the step for downloading the corresponding file from the download address is performed; when the file corresponding to the download address is stored, it is not necessary to download the file, and the link address where the corresponding file is stored is directly fed back to the user terminal provider.

In block 103, a sharing request including a link address sent by a user terminal requester is received, and a file corresponding to the link address is transmitted to the user terminal requester.

The user terminal requester may obtain the link address of the file through many means. For example, the user terminal provider may send the link address of a shared file to the user terminal requester. Conversely, the network side may publish the link address of a shared file, and the user terminal requester may obtain the link address of the corresponding file from the published information.

Before the sharing request including a link address sent by the user terminal requester is received, the method may further include the following: an authentication request including a link address sent by the user terminal requester is received; a determination as to whether the authentication request is legal is made, and when the authentication request is legal, a sharing request including the link address is generated according to a configured format, and the sharing request is returned to the user terminal requester.

The determination as to whether the authentication request is legal may include the following: access-permitted information corresponding to the link address included in the sharing request is extracted; the access-allowed information includes user terminal information and a time period; a determination as to whether the user terminal information includes information of the user terminal requester is made, when the user terminal information includes information of the user terminal requester, a determination as to whether current time is in the time period is further made, when the current time is in the time period, it is determined that the sharing request is legal; otherwise, it is determined that the sharing request is illegal. The access-allowed information corresponds to the link address, and each link address corresponds to one shared file. The access-allowed information is information sent to the network side by the user terminal provider after the file is downloaded, and content of the access-allowed information may be set as required. For example, the access-allowed information may only include user terminal information, only include a time period, include both of the user terminal information and the time period, or include other information as well as the user terminal information and the time period.

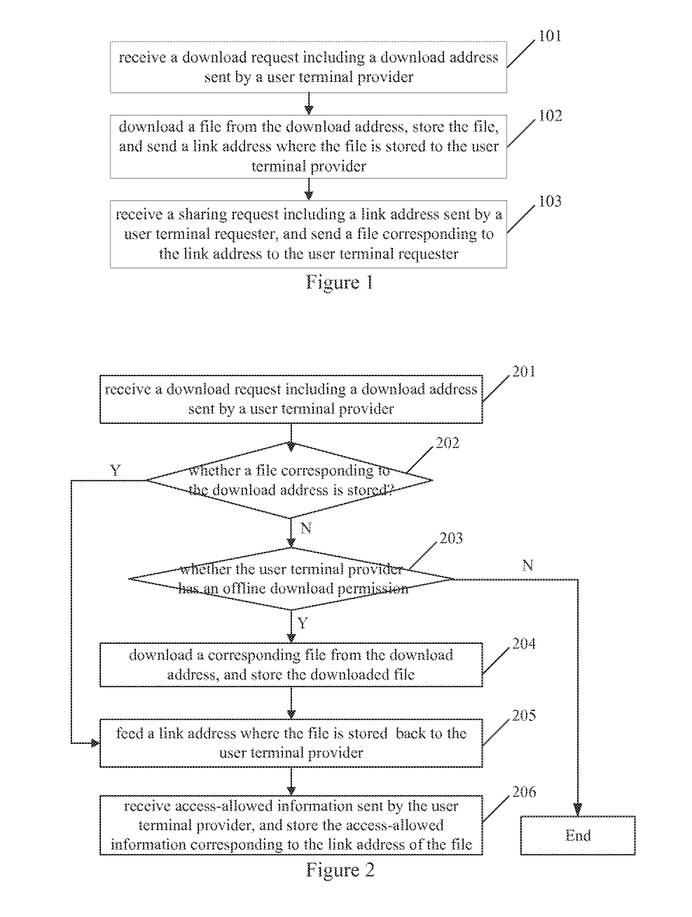

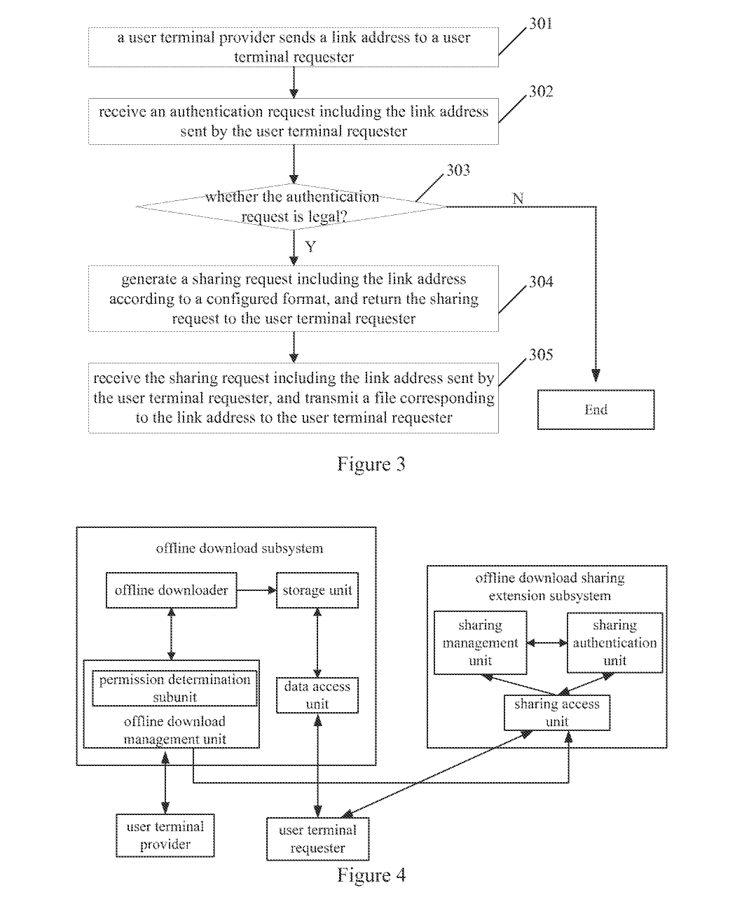

The method for sharing a file in the above example of the present disclosure will be described hereinafter with reference to various embodiments shown in FIG. 2 and FIG. 3.

FIG. 2 is a flowchart illustrating a method for downloading a file according to various embodiments of the present disclosure. As shown in FIG. 2, the method may include the following operations.

In block 201, a download request including a download address sent by a user terminal provider is received.

The user terminal provider may obtain the download address of a file to be downloaded through a website or other publishing means.

In block 202, a determination as to whether a file corresponding to the download address is stored is made; when no file corresponding to the download address is stored, proceed to block 203; when the file corresponding to the download address is stored, proceed to block 205.

In block 203, a determination as to whether the user terminal provider has an offline download permission is made; when the user terminal provider has the offline download permission, proceed to block 204; otherwise, the process is terminated.

In block 204, the corresponding file is downloaded from the download address and the downloaded file is stored.

According to different download addresses, the download method may include Hypertext transfer protocol (HTTP) download, BT download, ED2K download, and so on.

In block 205, a link address where the file is stored is fed back to the user terminal provider.

The link address may be expressed by a Hash value. While the link address is fed back to the user terminal provider, other relevant information of the file, such as file name keywords, file type, and file size, may be further fed back to the user terminal provider.

In block 206, access-allowed information sent by the user terminal provider is received, and the access-allowed information is stored corresponding to the link address of the file.

In the various embodiments, the access-allowed information includes user terminal information and a time period.

Block 205 may be performed before or after block 206, or block 205 and block 206 may be performed at the same time.

FIG. 3 is a flowchart illustrating a method for accessing a shared file according to various embodiments of the present disclosure. As shown in FIG. 3, the method may include the following operations.

In block 301, a user terminal provider sends a link address to a user terminal requester.

In block 302, an authentication request including the link address sent by the user terminal requester is received.

In block 303, a determination as to whether the authentication request is legal is made; when the authentication request is legal, proceed to block 304; otherwise, the process is terminated.

In block 304, a sharing request including the link address is generated according to a configured format, and the sharing request is returned to the user terminal requester.

In block 305, the sharing request including the link address sent by the user terminal requester is received, and a file corresponding to the link address is transmitted to the user terminal requester.

User terminal M shares animation A to describe the method of the present disclosure hereinafter. The example includes two parts, namely, downloading a file and accessing a shared file.

The first part: downloading file.

The network side receives a download request including a download address of animation A sent by user terminal M. The user terminal M is a user terminal provider. The network side determines that animation A is not stored, and determines that there is enough space left in storage space allocated for the user terminal M. The network side downloads animation A from the download address, stores the downloaded animation A, and feeds a link address where the animation A is stored back to the user terminal M, and simultaneously, may feed file name keywords, file type, file size, and the like back to user terminal M. Subsequently, the network side receives access-allowed information sent by the user terminal M, and stores the access-allowed information in a relationship associated with the link address of the animation A.

In the various embodiments, the access-allowed information includes a predetermined period of validity and a maximum value of the number of download users. The predetermined period of validity refers to a period starting from current moment during which the animation A may be accessed. Suppose the predetermined period of validity is 3 days. The maximum value of the number of download users refers to a maximum value of the number of users which are allowed to download the animation A at the same time. Suppose the maximum value of the number of download users is 4.

The second part: accessing shared file.

The user terminal M sends the link address of the animation A to the user terminal N. The user terminal N is a user terminal requester. The network side receives an authentication request including the link address of the animation A sent by the user terminal N and extracts access-allowed information corresponding to the link address of the animation A. The network side determines that current time is in the predetermined period of validity, namely 3 days, and the number of users currently downloading the animation A is 2, which is less than the maximum value 4 of the number of download users, and then determines that the authentication request is legal. The network side generates a sharing request including the link address of the animation A according to a configured format, and returns the sharing request to the user terminal N. Subsequently, the network side receives the sharing request including the link address of the animation A sent by the user terminal N, and transmits the animation A to the user terminal N.

In various embodiments, files downloaded by various user terminals are stored centrally, and a corresponding file is provided according to a sharing request including a link address of the file. Thus, it is not necessary for each user terminal to store the file in the local network, and the defect that the file sharing will not be performed when the user terminal provider is offline is also avoided.

In addition, in existing technology, even if the user terminal provider stores file data required by the user terminal requester, and the user terminal provider is online, but when the network connectivity between the user terminal provider and the user terminal requester is poor, and the size of the file is large, the existing means that file data is directly transmitted from the user terminal provider to the user terminal requester will consume a lot of time, and the data transmission rate is low. In contrast to the existing technology, in the present disclosure, the network side centrally stores the files downloaded by various user terminal providers, and the network side transmits requested data to the user terminal requester, which avoids the problem that the data transmission rate is low resulting from the direct transmission of data between two user terminals.

FIG. 4 is a diagram illustrating a system for sharing a file according to various embodiments of the present disclosure. As shown in FIG. 4, the system includes an offline download subsystem 400, and the offline download subsystem 400 includes an offline download management unit 410, an offline downloader 420, a storage unit 430, and a data access unit 440.

The offline download management unit 410 is configured to receive a download request including a download address sent by a user terminal provider, and send the download address in the download request to the offline downloader 420; receive a link address sent by the offline downloader 420, and feed the link address back to the user terminal provider.

The offline downloader 420 is configured to download a corresponding file from the download address, store the downloaded file in the storage unit 430, and send the link address where the file is stored to the offline download management unit 410.

The data access unit 440 is configured to receive a sharing request including a link address sent by a user terminal requester, obtain a file corresponding to the link address from the storage unit 430, and send the file to the user terminal requester.

In another example, the offline download management 410 unit may include a permission determination subunit 411, configured to determine whether the user terminal provider sending the download request has an offline download permission and, when the user terminal provider has the offline download permission, send the download address to the offline downloader 420; otherwise, not send the download address to the offline downloader 420.

In another example, the system may further include an offline download sharing extension subsystem 500, configured to receive an authentication request including a link address sent by the user terminal requester, determine whether the authentication request is legal and, when the authentication request is legal, generate a sharing request including the link address according to a configured format and return the sharing request to the user terminal requester.

In another example, the offline download sharing extension subsystem 500 may include a sharing access unit 510, a sharing management unit 520, and a sharing authentication unit 530.

The offline download management unit 410 is further configured to send access-allowed information corresponding to the link address where the file is stored to the sharing access unit 510.

The sharing access unit 510 is configured to receive the access-allowed information sent by the offline download management unit 410, and send the access-allowed information to the sharing management unit 520; receive an authentication request including the link address sent by the user terminal requester and transmit the authentication request to the sharing authentication unit 530, and receive the sharing request returned by the sharing authentication unit 530, and send the sharing request to the user terminal requester.

The sharing management unit 520 is configured to receive the access-allowed information from the sharing access unit 510 and store the access-allowed information in a relationship associated with the link address.

The sharing authentication unit 530 is configured to extract access-allowed information, which includes user terminal information and a time period, corresponding to the link address included in the sharing request from the sharing management unit 520, determine whether the user terminal information includes information of the user terminal requester, when the user terminal information includes information of the user terminal requester, determine whether current time is in the time period, when the current time is in the time period, determine that the authentication request is legal, generate a sharing request including the link address according to a configured format, and send the sharing request to the sharing access unit 510.

The access-allowed information corresponds to a link address. Each link address corresponds to one shared file. The access-allowed information is information sent to the network side by the user terminal provider after the file is downloaded, and content of the access-allowed information may be set as required; for example, the access-allowed information may only include user terminal information, only include a time period, include both of the user terminal information and the time period, or include other information as well as the user terminal information and the time period.

The user terminal of the present disclosure may be a mobile terminal, a personal computer (PC), and so on.

The foregoing description is only preferred examples of the present disclosure and is not used for limiting the protection scope thereof. Any modification, equivalent substitution, or improvement made without departing from the spirit and principle of the present disclosure should be covered by the protection scope of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

1. A method for sharing a file, comprising:
receiving a download request comprising a download address sent by a user terminal provider;
according to the download request, downloading a file from the download address, storing the file, and sending a link address where the file is stored to the user terminal provider;
receiving a sharing request comprising a link address sent by a user terminal requester, and sending a file corresponding to the link address to the user terminal requester.

2. The method according to claim 1, before downloading the file from the download address, the method further comprises:
determining whether the user terminal provider has an offline download permission;
when he user terminal provider has the offline download permission, downloading the file from the download address.

3. The method according to claim 2, where determining whether the user terminal provider has the offline download permission comprises:
determining whether storage space is allocated for the user terminal provider;
when the storage space is allocated for the user terminal provider, determining whether there is enough space left in allocated storage space;
when there is enough space left in the allocated storage space, determining that the user terminal provider has the offline download permission.

4. The method according to claim 1, before downloading the file from the download address, the method further comprises:
determining whether the file corresponding to the download address is stored;
when the file corresponding to the download address is not stored, downloading the file from the download address.

5. The method according to claim 1, before receiving the sharing request comprising the link address sent by the user terminal requester, the method further comprises:
the user terminal provider sending the link address to the user terminal requester.

6. The method according to claim 1, before receiving the sharing request comprising the link address sent by the user terminal requester, the method further comprises:
receiving an authentication request comprising the link address sent by the user terminal requester;
determining whether the authentication request is legal;
when the authentication request is legal, generating the sharing request comprising the link address according to a configured format;
sending the sharing request to the user terminal requester.

7. The method according to claim 6, wherein determining whether the authentication request is legal comprises:
extracting access-allowed information corresponding to the link address in the sharing request; wherein the access-allowed information comprises user terminal information and a time period;
determining whether the user terminal information comprises information of the user terminal requester;
when the user terminal information includes information of the user terminal requester, determining whether current time is in the time period;
when the current time is in the time period, determining that the sharing authentication request is legal.

8. A system for sharing a file, comprising: a first subsystem, wherein the first subsystem comprises a first processor and a first memory in communication with the first processor; the first memory comprises an offline download management unit, an offline downloader, a storage unit and a data access unit which may be executed by the first processor;
the offline download management unit is configured to receive a download request comprising a download address sent by a user terminal provider, and send the download address to the offline downloader; receive a link address sent by the offline downloader, and send the link address to the user terminal provider;
the offline downloader is configured to download a file from the download address, store the downloaded file in the storage unit, and send the link address where the file is stored to the offline download management unit;
the data access unit is configured to receive a sharing request comprising a link address sent by a user terminal requester, obtain a file corresponding to the link address from the storage unit, and send the file to the user terminal requester.

9. The system according to claim 8, wherein the offline download management unit comprises a permission determination subunit, configured to determine whether the user terminal provider sending the download request has an offline download permission, when the user terminal provider has the offline download permission, send the download address to the offline downloader; otherwise, not send the download address to the offline downloader.

10. The system according to claim 8, further comprising a second subsystem, wherein the second subsystem comprises a second processor and a second memory in communication with the second processor; the second memory stores modules which may be executed by the second processor receive an authentication request comprising a link address sent by the user terminal requester, determine whether the authentication request is legal, when the authentication request is legal, generate a sharing request including the link address according to a configured format, and return the sharing request to the user terminal requester.

11. The system according to claim 10, wherein the second memory comprises: a sharing access unit, a sharing management unit and a sharing authentication unit;
the offline download management unit is further configured to send access-allowed information corresponding to the link address where the file is stored to the sharing access unit;
the sharing access unit is configured to receive the access-allowed information sent by the offline download management unit, and send the access-allowed information to the sharing management unit; receive an authentication request comprising the link address sent by the user terminal requester, and send the authentication request to the sharing authentication unit; receive the sharing request returned by the sharing authentication unit, and send the sharing request to the user terminal requester;
the sharing management unit is configured to receive the access-allowed information from the sharing access unit, and store the access-allowed information in a relationship associated with the link address;
the sharing authentication unit is configured to extract access-allowed information corresponding to the link address in the sharing request from the sharing management unit, wherein the access-allowed information includes user terminal information and a time period; determine whether the user terminal information comprises the user terminal requester, when the user terminal information comprises information of the user terminal requester, determine whether current time is in the time period, when the current time is in the time period, determine that the authentication request is legal, generate the sharing request comprising the link address according to a configured format, and send the sharing request to the sharing access unit.

12. A computer readably storage medium, the computer readable storage medium stores one or more programs, which may be executed by one or more processors for performing the method for sharing a file according to any one of claims 1 to 7.
